(19) United States
(12) Patent Application Publication
(10) Pub. No.: US 2023/0420787 A1
(43) Pub. Date: Dec. 28, 2023

(54) BATTERY PACK BRACKET INTEGRATION

(71) Applicant: Rivian IP Holdings, LLC, Irvine, CA (US)

(72) Inventors: Ehsan Baseri, Irvine, CA (US); Brandon Thayer, Aliso Viejo, CA (US); Michael Tillapaugh, Racho Mission Viejo, CA (US); Pierluigi Leccese, Irvine, CA (US); Andrew Krasts, San Clementi, CA (US)

(21) Appl. No.: 17/848,892

(22) Filed: Jun. 24, 2022

(51) Int. Cl. H01M 50/291; B60L 50/64; H01M 50/249; H01M 10/613; H01M 10/625; H01M 10/6557

(52) U.S. Cl. CPC H01M 50/291; B60L 50/64; H01M 50/249; H01M 10/613; H01M 10/625; H01M 10/6557; H01M 2220/20

(57) ABSTRACT

An apparatus can include a member a member to extend between a first structural member and a second structural member. The apparatus can include at least one connection point integrated with the member. The at least one connection point can be configured to facilitate a fluid coupling between a cooling line and a cooling component. The apparatus can include at least one end portion of the member. The at least one end portion can be configured to interface with a seat of at least one of the first structural member and the second structural member.

### INTRODUCTION

Battery packs can be a source of electrical power. Battery packs can be assembled from various components.

### SUMMARY

At least one aspect is directed to an apparatus. The apparatus can include a member to extend between a first structural member and a second structural member. The apparatus can include at least one connection point integrated with the member. The at least one connection point can be configured to facilitate a fluid coupling between a cooling line and a cooling component. The apparatus can include at least one end portion of the member. The at least one end portion can be configured to interface with a seat of at least one of the first structural member and the second structural member.

At least one aspect is directed to an apparatus. The apparatus can include a base. The apparatus can include a divider extending vertically from the base. The divider can be configured to separate a first side of the base from a second side of the base. The apparatus can include at least one sidewall disposed on at least one of the first side and the second side of the base. The at least one sidewall can include a tab region.

At least one aspect is directed to a method. The method can include disposing a bracket within a battery pack. The bracket can include a member to extend between a first structural member and a second structural member of the battery pack. The bracket can include at least one connection point integrated with the member. The at least one connection point can be configured to facilitate a fluid coupling between a cooling line and a cooling component within the battery pack. The bracket can include at least one end portion of the member. The method can include interfacing the at least one end portion of the bracket with a seat of at least one of the first structural member and the second structural member.

At least one aspect is directed to a method. The method can include aligning a bracket with a cutout of a structural member. The structural member can extend between a first side of a battery pack and a second side of the battery pack. The bracket can include a base to interface with the cutout of the structural member. The bracket can include a divider extending vertically from the base. The divider can be configured to separate a first side of the base from a second side of the base. The bracket can include at least one sidewall disposed on at least one of the first side and the second side of the base. The at least one sidewall can include a tab region. The method can include disposing the bracket within the cutout of the structural member.

At least one aspect is directed to a system. The system can include a plurality of structural members extending between a first side of a battery pack and a second side of the battery pack. The plurality of structural members can include a first structural member and a second structural member. The system can include a bracket configured to form a bridge between the first structural member and the second structural member. The bracket can include a member to extend between the first structural member and the second structural member. The bracket can include at least one connection point integrated with the member. The at least one connection point can be configured to facilitate a fluid coupling between a cooling line and a cooling component within the battery pack. The bracket can include a first end portion of the member and a second end portion of the member. The first end portion can be configured to interface with a seat of the first cross member and the second end portion can be configured to interface with a seat of the second cross member.

At least one aspect is directed to a system. The system can include a structural member configured to separate a first battery module of a battery pack from a second battery module of the battery pack. The structural member can include a cutout. The system can include a bracket configured to be disposed within the cutout of the structural member. The bracket can include a base. The bracket can include a divider extending vertically from the base. The divider can be configured to separate a first side of the base from a second side of the base. The bracket can include at least one sidewall disposed on at least one of the first side and the second side of the base. The sidewall can include a tab region. The first side of the base can be configured to support a busbar. The busbar can be configured to electrically couple the first battery module with the second battery module.

At least one aspect is directed to an electric vehicle. The electric vehicle can include a battery pack configured to power the electric vehicle. The battery pack can include a plurality of battery modules. The battery pack can include a plurality of structural members to separate the plurality of battery modules. The battery pack can include at least one bracket. The at least one bracket can include a member to extend between a first structural member of the plurality of structural members and a second structural member of the plurality of structural members. The at least one bracket can include at least one connection point integrated with the member. The at least one connection point can be configured to facilitate a fluid coupling between a cooling line and a cooling component within the battery pack. The at least one bracket can include a first end portion disposed at a first end of the member and a second end portion disposed at a second end of the member. The first end portion can be configured to interface with a seat of the first structural member and the second end portion configured to interface with a seat of the second structural member.

At least one aspect is directed to an electric vehicle. The electric vehicle can include a battery pack configured to power the electric vehicle. The battery pack can include a plurality of battery modules. The battery pack can include at least one structural member to separate the plurality of battery modules. The battery pack can include at least one bracket. The at least one bracket can include a base. The at least one bracket can include a divider extending vertically from the base. The divider can be configured to separate a first side of the base from a second side of the base. The at least one bracket can include at least one sidewall disposed on at least one of the first side and the second side of the base. The at least one sidewall can include a tab region. The first side of the base can be configured to support a busbar. The busbar can be configured to electrically couple a first battery module of the plurality of battery modules with a second battery module of the plurality of modules.

At least one aspect is directed to a method. The method can include providing a bracket. The bracket can include a member to extend between a first structural member and a second structural member of a battery pack. The bracket can include at least one connection point integrated with the member. The at least one connection point can be configured to facilitate a fluid coupling between a cooling line and a cooling component within the battery pack. The bracket can include at least one end portion of the member. The at least one end portion can be configured to interface with a seat of at least one of the first structural member and the second structural member.

At least one aspect is directed to a method. The method can include providing a bracket. The bracket can include a base. The bracket can include a divider extending vertically from the base. The divider can be configured to separate a first side of the base from a second side of the base. The bracket can include at least one sidewall disposed on at least one of the first side and the second side of the base. The at least one sidewall can include a tab region.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with some aspects.

FIG. 2A depicts an example battery pack, in accordance with some aspects.

FIG. 2B depicts example battery modules, in accordance with some aspects.

FIG. 3 depicts an example bracket, in accordance with some aspects.

FIG. 4 depicts an example battery pack, in accordance with some aspects.

FIG. 5 depicts an example battery pack, in accordance with some aspects.

FIG. 6 depicts an example bracket, in accordance with some aspects.

FIG. 7 depicts an example bracket, in accordance with some aspects.

FIG. 8 depicts an example bracket, in accordance with some aspects.

FIG. 9 depicts an example battery pack, in accordance with some aspects.

FIG. 10 depicts an example battery pack, in accordance with some aspects.

FIG. 11 depicts a flow diagram illustrating an example method to install a bracket, in accordance with some aspects.

FIG. 12 depicts a flow diagram illustrating an example method to install a bracket, in accordance with some aspects.

FIG. 13 depicts a flow diagram illustrating an example method to provide a bracket, in accordance with some aspects.

FIG. 14 depicts a flow diagram illustrating an example method to install a plurality of brackets, in accordance with some aspects.

### DETAILED DESCRIPTION

Following below are more detailed descriptions of various concepts related to, and implementations of, methods, apparatuses, and systems of a bracket. The various concepts introduced above and discussed in greater detail below may be implemented in any of numerous ways.

The present disclosure is generally directed to integrated battery pack brackets designed to consolidate and replace various components of a battery pack as well as simplify installation of the bracket.

A first bracket of the disclosure can simplify the installation of the components used to fluidly couple a cooling manifold with a thermal or cooling component (e.g., a cold plate) of the battery pack. The bracket can combine various components into the single bracket design and eliminate the need to use tools and fasteners to secure the bracket in its proper position. This bracket design can reduce a likelihood of various components or objects causing short circuits between the components of the battery pack and a high voltage distribution system. The bracket can include connection points to retain quick connect components such that cooling lines within the battery pack can be easily coupled with the bracket and positioned for the cooling line to be fluidly coupled with a thermal component. The bracket can be dropped into the battery pack with the connection points already in the proper positions to facilitate an easy connection. The bracket can include end portions to secure the bracket in position without requiring additional tools or fasteners. For example, to ensure correct positioning, the end portions can include an opening configured to receive an alignment pin of a lower cross member. With the alignment pin disposed within the opening, the end portion of the bracket can be clamped between the lower cross member and an upper cross member. Fastening the upper cross member with the lower cross member can apply enough force on the bracket to secure the bracket in place.

A second bracket can simplify the installation and support of components used to transfer current between components of the battery pack. The second bracket can combine various components into the single bracket design and eliminate the need to use tools and fasteners to secure the bracket in its proper position. The second bracket can include a base to support busbars that connect modules from different bays within the battery pack, a wall to separate the busbars and remove the need for a separate element (e.g., a mica sheet) to be disposed between the busbars, connection points to mechanically retain a harness that carries current to various components of the battery pack, and tab regions to support a mica sheet that lays on the top of the modules within the battery pack, for example. The single second bracket can be installed into the battery pack in a single step. The second bracket can also include locating features that extend from a bottom surface of the base to secure proper placement of the bracket with respect to a cross member without requiring additional tools or fasteners. With the locating features disposed in corresponding cavities of the upper cross member, the base of the bracket can be clamped between the upper cross member and the busbars when the busbars are bolted in place. Bolting the busbars with modules of the battery pack can apply enough force on the bracket to secure the bracket in place.

Both brackets disclosed herein can be installed from a single side of the battery pack such that the other sides of the battery pack can be sealed, and the battery pack does not need to be flipped over numerous times during installation, for example. Additionally, both brackets can be secured in position without the use of tools or fasteners. Each bracket can be clamped between other components of the battery pack such that securing the other components automatically secures the brackets.

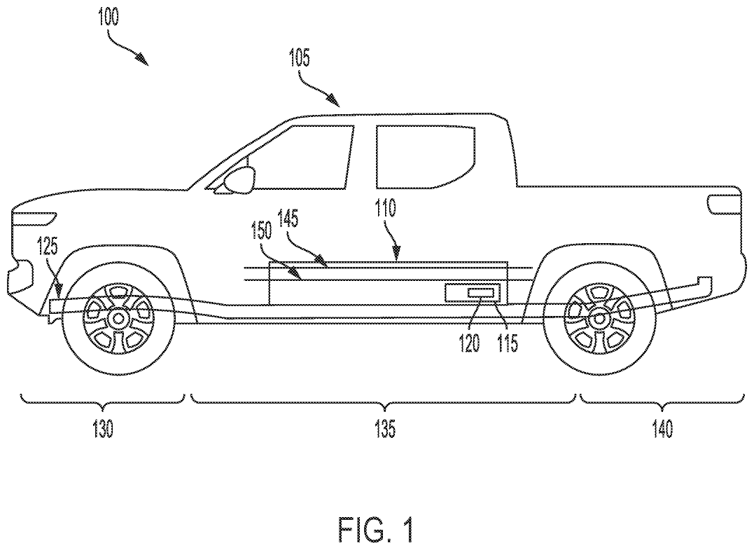

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Yet, it should also be noted that battery pack 110 may also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

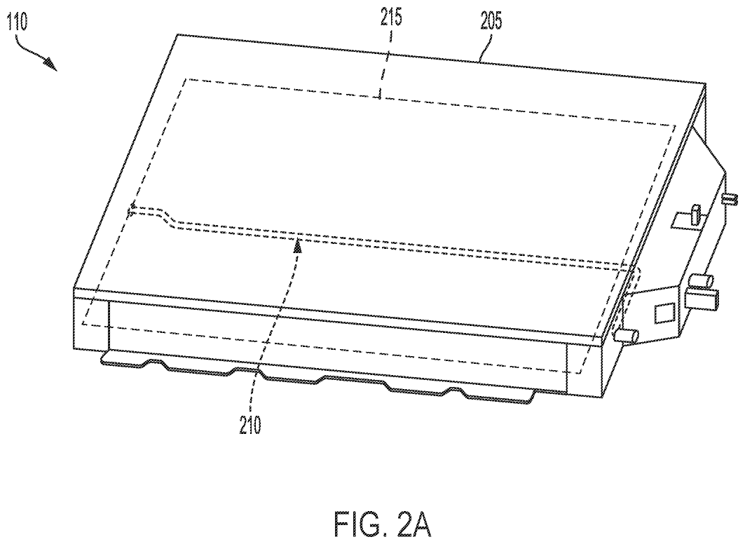

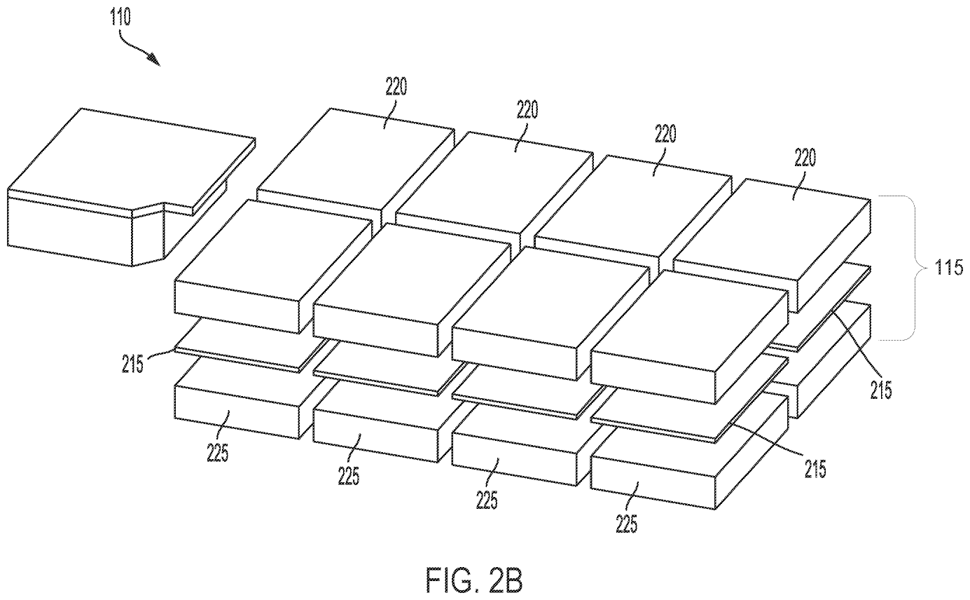

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom and/or underneath the battery module 115 to protect the battery module 115 from external conditions, particularly if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. While the cooling line 210 and the thermal component 215 can refer to cooling functions, the same or similar components can be used for other thermal functions, such as, for example, providing heat the battery pack 110. For example, when the battery pack 110 is exposed to cold temperatures, the cooling line 210 and thermal component 215 can provide heat to the battery pack 110 to prevent a temperature of the battery pack 110 and any internal components (e.g., the battery modules 115) from falling below a temperature threshold. In some instances, the thermal component 215 may be positioned in relation to a top submodule and a bottom submodule, such as in between the top and bottom submodules, among other possibilities. The battery pack 110 can include any number of thermal components 215. For example, there can be one or more thermal components 215 per battery pack, or per battery module 115. The cooling line 210 can be coupled with, part of, or independent from the thermal component 215.

FIG. 2B depicts example battery modules 115. The battery modules 115 can include at least one submodule. For example, the battery modules 115 can include at least one top submodule 220 or at least one bottom submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. The battery pack 110 can include any number of thermal components 215. For example, the battery pack 110 can include one thermal component 215 for the entire battery pack 110, one thermal component 215 for each battery module 115, a plurality of thermal components 215 for each battery module 115, or one thermal component 215 for a subset of the plurality of battery modules 115. It should also be noted that each battery module 115 may include a top submodule 220 and a bottom submodule 225, possibly with a thermal component 215 in between the top submodule 220 and the bottom submodule 225. The battery pack 110 can include or define a plurality of areas (e.g., bays, pods, etc.) for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

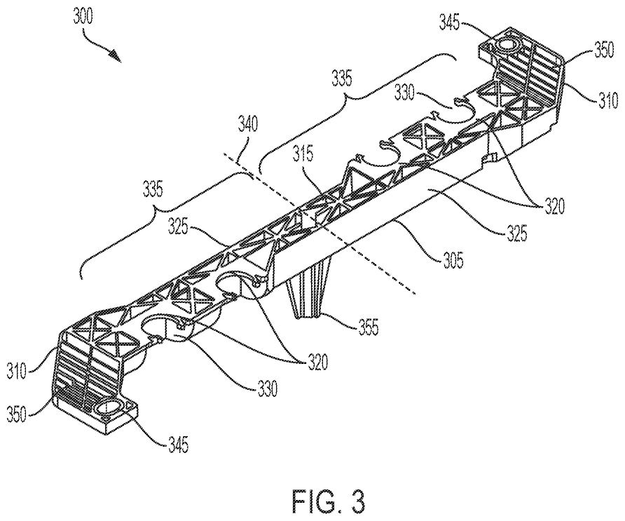

FIG. 3 depicts an example apparatus. The apparatus can be or include bracket 300. The bracket 300 can comprise a single structure configured to simplify installation of components used to fluidly couple a cooling manifold with a thermal component 215 (e.g., a cold plate) of a battery pack 110. While the cooling manifold and the thermal component 215 can refer to cooling functions, the cooling manifold and the thermal component 215 can also be used for other thermal purposes, such as, for example, heating a battery pack or components of the battery pack. The bracket 300 can include at least one member 305. Member 305 can be or include at least one elongated portion or be or include any other shape, size, or orientation. The member 305 can have a structure configured to maintain a shape and provide connection points to facilitate the coupling between the cooling manifold and the cooling system of the battery pack. The member 305 can be a solid structure. The member 305 can be a hollow structure. The member 305 can include at least one void 315. The void 315 can be any shape, size, or orientation. The void 315 can reduce the overall weight of the bracket 300. The void 315 can be configured to facilitate other functions within the battery pack. For example, the void 315 can be a receptacle for an element within the battery pack, a locating feature to ensure alignment of the bracket 300 with other features of the battery pack, among others things. Member 305 can comprise any material capable of retaining its shape and performing its expected functions. For example, member 305 can be a metal or plastic that is strong enough to retain its shape and perform the functions described herein.

The member 305 can include at least one connection point 320. The connection point 320 can be integrated with the member 305. For example, the connection point 320 can be an opening defined by the member 305. The connection point 320 can receive a component of the battery pack. For example, the connection point 320 can receive a cooling line of the battery pack. The connection point 320 can facilitate a fluid coupling between a cooling line and a cooling component. For example, the connection point 320 can facilitate a fluid coupling between a cooling line and a cold plate. The connection point 320 can secure a connection device configured to couple the cooling line with the bracket 300. For example, the connection point 320 can secure a quick-connect device such that the cooling line can snap into place to be coupled with the bracket 300. The connection point 320 can be disposed on a side 325 of the member 305. The connection point 320 can have any shape configured to receive the component of the battery pack. For example, the connection point 320 can have a circular shape. The connection point 320 can be disposed along a side 325 of the member 305 such that the connection point 320 creates a gap 330 in the side 325 of the member 305. A component of the battery pack can enter the connection point 320 via the gap 330.

The member 305 can define a plurality of connection points 320. For example, a first connection point 320 can be disposed on a first side 325 of the member 305 and a second connection point 320 can be disposed on a second side 325 of the member 305. The plurality of connection points 320 can also be on the same side 325 of the member 305. The member 305 can be defined as the portion of the bracket 300 comprising all of the plurality of connection points 320.

The member 305 can have two symmetrical (plus or minus 10%) sections 335. A first section 335 can be on a first side of a centerline 340 of the member 305 and the second section 335 can be on a second side of a centerline 340 of the member 305. The symmetry can be, for example, rotational symmetry wherein the first section 335 can be rotated about a central axis to create the second section 335. For example, the first section 335 can have two connection points 320 disposed on the first side 325 of the member 305. The first connection point 320 can be a first distance from the centerline 340 of the member 305 and the second connection point 320 can be a second distance from the centerline 340 of the member 305. The second section 335 can have two connection points 320 (a third and a fourth connection point 320) of the same size and shape as the first section 335 but be disposed on a second side 325 of the member 305. The third connection point 320 can be the first distance from the centerline 340 and the fourth connection point 320 can be the second distance from the centerline 340. The symmetry can also be, for example, reflection (mirror) symmetry wherein the first section 335 is a reflection of the second section 335 across the centerline 340. For example, the first section 335 can have two connection points 320 disposed on a first side 325 of the member 305. The first connection point 320 can be a first distance from the centerline 340 of the member 305 and the second connection point 320 can be a second distance from the centerline 340 of the member 305. The second section 335 can have two connection points 320 (a third and a fourth connection point 320) of the same size and shape as the first section 335 also disposed on the first side 325 of the member. The third connection point 320 can be the first distance from the centerline 340 and the fourth connection point 320 can be the second distance from the centerline 340.

The end portion 310 can be disposed at an end of the member 305. The end portion 310 can be configured to secure the bracket 300 in a position within a battery pack. For example, the end portion 310 can be clamped between two components of the battery pack. The end portion 310 can include at least one opening 345. The end portion 310 can extend from the end of the member 305 such that the opening 345 is offset from the member 305. The end portion 310 can extend from the end of the member 305 such that the opening 345 is aligned with the member 305. The opening 345 can receive a component of a battery pack to facilitate the positioning and the securing of the bracket 300 within the battery pack. For example, the opening 345 can receive an alignment pin of the battery pack. The end portion 310 can include at least one locating feature 350. The locating feature 350 can be configured to receive a component of the battery pack. For example, the shape, size, and orientation of the locating feature 350 can correspond with a size, shape, and orientation of the component of the battery pack such that the component can fit within the locating feature 350 and be secured within the locating feature 350. For example, the locating feature 350 can be a slot, a groove, a channel, a recess, etc. configured to retain a component of the battery pack. The shape size, and orientation of the locating feature 350 can be configured to facilitate proper placement of the component.

The bracket 300 can include a plurality of end portions 310. For example, a first end portion 310 can extend from a first end of the member 305 and a second end portion 310 can extend from a second end of the member 305. Similar to the member 305, the plurality of end portions 310 can be symmetrical. For example, a first end portion 310 can be rotationally symmetrical with a second end portion 310. For example, the first end portion 310 can be configured such that an opening 345 of the first end portion 310 is disposed at a location offset from a first side 325 of the member 305 and the second end portion 310 can be configured such that an opening 345 of the second end portion 310 is disposed at the location but offset from a second side 325 of the member 305. The first end portion 310 can also be reflectively symmetrical with the second end portion 310. For example, the first end portion 310 can be configured such that the opening 345 of the first end portion 310 is disposed at a location offset from the first side 325 of the member 305 and the second end portion 310 can be configured such that the opening 345 of the second end portion 310 is disposed at the location also offset from the first side 325 of the member 305.

The end portion 310 may extend from a section 335 of the member 305 wherein the section 335 comprises a connection point 320 disposed on a first side of the member 305. The opening 345 of the end portion 310 may be offset from the member on the same side 325 as the connection point 320 or on the opposite side 325 from the connection point 320.

The bracket 300 can include at least one protrusion 355. The protrusion 355 can extend from the member 305 of the bracket 300. The protrusion 355 can extend from a bottom surface of the member 305. The protrusion 355 can be disposed centrally (plus or minus 10%) with respect to the member 305. The protrusion 355 can have any shape. The protrusion 355 can have a height greater than a height of the bracket 300. The protrusion 355 can also have a height equal to or less than the height of the bracket 300. The protrusion 355 can support a component of a battery pack. For example, the protrusion 355 can support a cooling line of a battery pack.

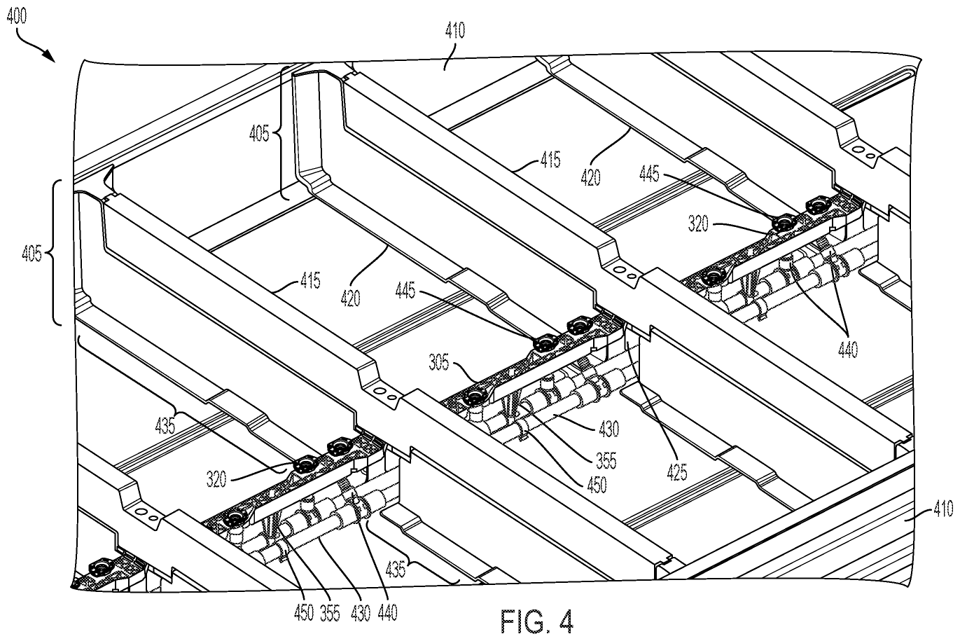

FIG. 4 depicts a battery pack 400. Battery pack 400 can be battery pack 110. Battery pack 400 can include at least one bracket 300 and at least one structural member 405. Structural member 405 can extend between a first side 410 of the battery pack 400 and a second side 410 of the battery pack 400. Structural member 405 can include an upper member 415 and a lower member 420. The upper member 415 can be coupled with the lower member 420. For example, the upper member 415 can be coupled with the lower member 420 via a bolt. The lower member 420 can define a passage 425. The passage 425 may provide space for components of the battery pack 400 to pass through. For example, a cooling line 430 of the battery pack 400 can extend through the passage 425. The passage 425 can be defined by an opening or a cutout of the lower member 402. The passage 425 can also be defined by a space between a first portion 435 of the lower member 420 and a second portion 435 of the lower member 420. The first portion 435 and the second portion 435 can be separate portions of the lower member 420.

The protrusion 355 extending from the bottom surface of the member 305 can be configured to keep the cooling line 430 in place. For example, the protrusion 355 can include or can be coupled with a coupling mechanism 450. The coupling mechanism 450 can comprise a grip configured to retain cooling line 430. The coupling mechanism 450 can include a plurality of grips configured to retain a plurality of cooling lines 430. The protrusion 355 can keep a cooling line 430 parallel (plus or minus 10 degrees) with the member 305 of the bracket 300. The protrusion 355 can couple with a plurality of components within the battery pack 400.

The bracket 300 can include at least one connection point 320 disposed at a location along the member 305 to longitudinally align with a branch 440 of the cooling line 430 when the bracket 300 is installed in a battery pack. For example, the connection point 320 can be a longitudinal distance away from the centerline 340 of the member 305. The branch 440 of the cooling line 430 can be the same longitudinal distance away from the centerline 340 of the member 305. The connection point 320 can be vertically offset from the cooling line 430 such that the branch 440 can vertically offset from the cooling line 430 to be received by the connection point 320. The connection point 320 can also be vertically aligned with the cooling line 430 such that the branch 440 can extend vertically to be received by the connection point 320. The branch 440 can couple directly with the connection point 320 or the branch 440 can couple with the connection point 320 via a connection device 445 (e.g., a quick connect device) that facilitates quick and easy connection.

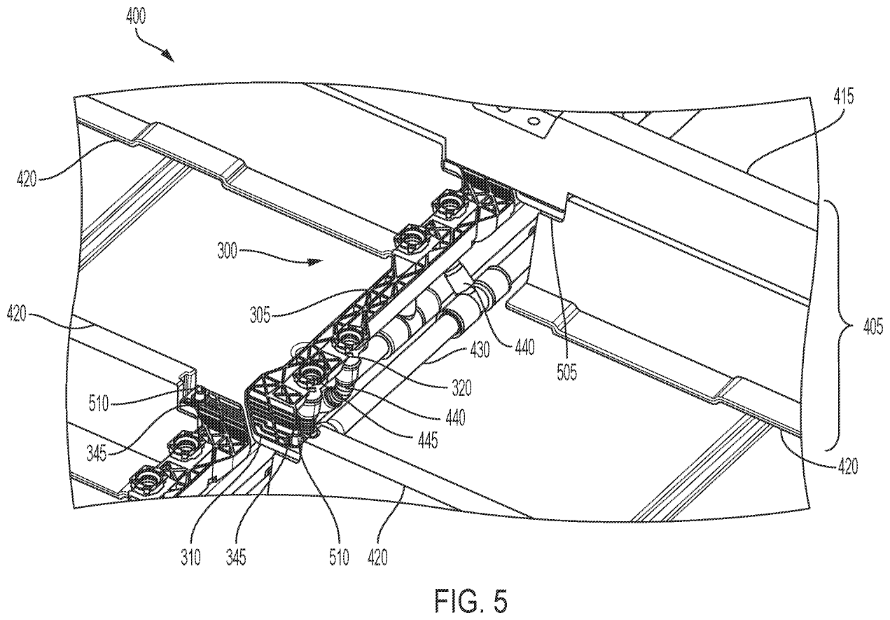

FIG. 5 depicts a portion of the battery pack 400. Lower member 420 can include at least one seat 505. The seat 505 can be configured to support the bracket 300. For example, an end portion 310 of the bracket 300 can interface with the seat 505. The end portion 310 can rest on the seat 505 such that the seat 505 supports the bracket 300. The seat 505 can include an alignment pin 510. The alignment pin 510 can facilitate proper positioning and securing of the bracket 300. For example, the opening 345 of the end portion 310 of the bracket 300 can be configured to receive the alignment pin 510 when disposed in the battery pack 400. When the alignment pin 510 is disposed within the opening 345, the end portion 310 can interface with the seat 505.

To secure the bracket 300 in place, the end portion 310 can be clamped. For example, the end portion 310 can be configured to be clamped between the upper member 415 and the lower member 420. A bottom surface of the end portion 310 can interface with the seat 505 of the lower member 420 and an upper surface of the end portion 310 can interface with a bottom of the upper member 415. As the upper member 415 is coupled with the lower member 420, a pressure can be applied to the end portion 310 such that the bracket 300 can be secured in its position. The bracket 300 can be installed in the battery pack 400 without tools or fasteners. For example, when installed, the bracket 300 interfaces with the upper member 415 and the lower member 420. There can be no fastener directly coupling the bracket 300 with another component. For example, there can be no fastener coupling the bracket 300 with the upper member 415 and no fastener coupling the bracket 300 with the loser member 420. Therefore, the bracket 300 can be secured in a position in an absence of a fastener.

Battery pack 400 can include a plurality of structural members 405. For example, the battery pack 400 can include a first structural member 405 and a second structural member 405. The plurality of structural members 405 can extend between a first side of the battery pack 400 and a second side of the battery pack 400. Bracket 300 can form a bridge between the first structural member 405 and the second structural member 405. For example, the member 305 of the bracket 300 can extend between the first structural member 405 and the second structural member 405. The member 305 can include a first end portion 310 and a second end portion 310. The first end portion 310 can receive an alignment pin 510 of the first structural member 405 and interface with a seat of the first structural member 405. The second end portion 310 can receive an alignment pion 510 of the second structural member 405 and interface with a seat of the second structural member 405. The first end portion 310 can be clamped between an upper member 415 and a lower member 420 of the first structural member 405 and the second end portion 310 can be clamped between an upper member 415 and a lower member 420 of the second structural member 405.

The member 305 of the bracket 300 can include a plurality of connection points 320. For example, a first and a second connection point 320 can be disposed on a first section 335 of the member 310 and on a first side 325 of the member 305. A third and fourth connection point 320 can be disposed on a second section 335 of the member 310 and on a second side 325 of the member 305. Each of the four connection points 320 can longitudinally align with a branch 440 of a cooling line 430. Each branch 440 can couple with the bracket 300 via a connection device 445. Coupling of the branches 440 of the cooling lines 430 with the connection points 320 of the member 305 of the bracket 300 can facilitate a fluid coupling between the cooling lines 430 and a thermal component 215 of the battery pack 400.

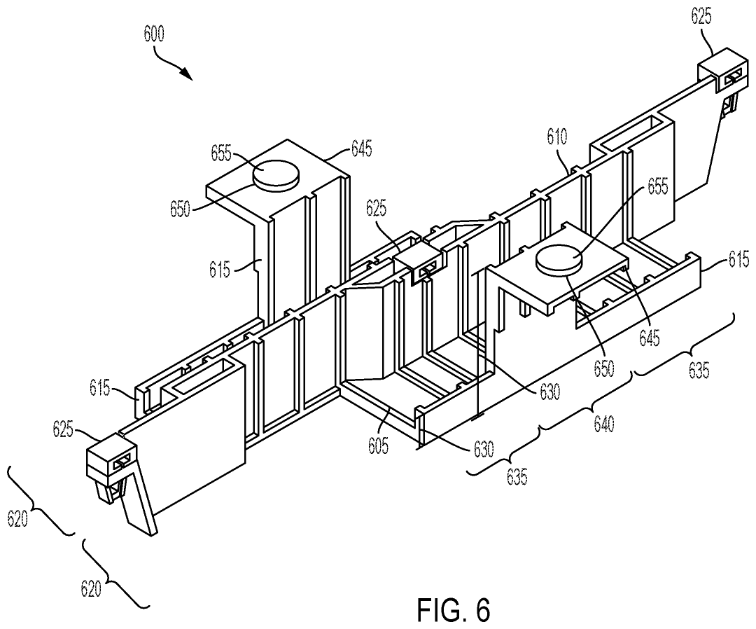

FIG. 6 depicts an example apparatus. The apparatus can be bracket 600. The bracket 600 can comprise a single structure that simplifies installation of components of a battery pack. The bracket 600 can include at least one base 605, at least one divider 610, and at least one sidewall 615. The base 605 can support a component of a battery pack. For example, the base 605 can be a horizontal platform configured to support the component. A face of the base 605 can have a planar, flat surface or the face can include ridges or other features extending from the surface of the base 605. The base 605 can support a busbar of a battery pack. For example, a surface of the busbar can be configured to interface with the surface of the base 605 (e.g., the face of the base 605 or the features extending from the face). The base 605 can comprise a material configured to retain its shape and support other components of a battery pack. The material can also be an insulating material such that current flowing through a busbar that is being supported by the base 605 will not transfer to the base 605.

The divider 610 can extend vertically from the base 605. The divider 610 can comprise a straight shape or can have a shape with at least one offset. The divider 610 can separate a first side 620 of the base 605 from a second side 620 of the base 605. The first side 620 can be aligned with the second side 620, or the first side 620 can be offset from the second side 620. The first side 620 can support a first component of a battery pack and the second side 620 can support a second component. For example, the first side 620 can support a first busbar and the second side 620 can support a second busbar. The divider 610 can separate the first busbar from the second busbar. The divider 610 can be the same material as the base 605 or a different material. The divider 610 can provide insulation between the first busbar and the second busbar. For example, the divider 610 can extend the length of the base 605, can extend beyond the length of the base 605, or can be shorter than the base 605. The length of the divider 610 can be based on where the first busbar is adjacent to the second busbar. For example, the divider 610 can be long enough such that no part of the first busbar can contact any part of the second busbar. The divider 610 can comprise an insulating material such that current cannot transfer between busbars through the divider 610.

The divider 610 can include at least one connector 625. The connector 625 can be integrated with the divider 610 or can be coupled with the divider 610. For example, the connector 625 can snap to the divider 610. The connector 625 can mechanically retain a component of a battery pack. For example, the connector 625 can mechanically retain a harness of a battery pack. The harness can connect low voltage features together within the battery pack. The harness can, for example, snap into the connector 625. The divider 610 can include a plurality of connectors 625. The plurality of connectors 625 can be disposed at different locations along the divider 610. For example, a first connector 625 can be coupled at a first end of the divider 610, a second connector 625 can be coupled proximate a center (plus or minus 10%) of the divider 610, and a third connector 625 can be coupled at a second end of the divider 610. Each of the plurality of connectors 625 can be configured to retain the harness such that the harness can travel along the divider 610. Each of the plurality of connector 625 can also be configured to retain different components of the battery pack.

The bracket 600 can include at least one sidewall 615. The sidewall 615 can be disposed on at least one of the first side and the second side of the base 605. The sidewall 615 can extend vertically from an edge of the base 605. The sidewall 615 can have a single wall height 630. For example, the sidewall 615 can have a uniform height 630 across an entire width of the sidewall 615. The sidewall 615 can also have a plurality of wall heights 630. For example. A first outer portion 635 can have a first height 630, an inner portion 640 can have a second height 630, and a second outer portion 635 can have a third height 630. The first height 630 and the third height 630 can be the same height 630 or different heights 630. The inner portion 640 can be centered between the first outer portion 635 and the second outer portion 635. The inner portion 640 can also be offset from the center between the first outer portion 635 and the second outer portion 635. The sidewall 615 can be the same material as the base 605 or a different material. The sidewall 615 can provide insulation between a busbar and other components of a battery pack. For example, the sidewall 615 can separate the busbar from a structural member of the battery pack. The sidewall 615 can comprise an insulating material such that current cannot transfer to the sidewall 615 and to other components of the battery pack.

The sidewall 615 can include at least one tab region 645. The tab region 645 can extend along the entire sidewall 615 or a portion of the sidewall 615. For example, the tab region 645 can extend from the inner portion 640 of the sidewall 615. The tab region 645 can extend from an upper edge of the sidewall 615. The tab region 645 can extend horizontally (plus or minus 10 degrees) from the sidewall 615. The tab region 645 can extend at other angles from the sidewall 615. The tab region 645 can be the same material as the sidewall 615 or a different material. The tab region 645 can be any material such that the tab region 645 can retain its shape when performing the functions described herein.

The tab region 645 can include at least one projection 650. The projection 650 can be disposed on the tab region 645. For example, the projection 650 can extend vertically from an upper surface of the tab region 645. The projection 650 can comprise any shape. A face 655 of the projection 650 can be a planar surface. For example, the face 655 can be a flat surface such that a sheet-like material can lay flat across the face 655. The projection 650 can be configured to support a sheet-like component. For example, the projection 650 can support a mica sheet of a battery pack. The projection 650 can align with a locating feature of the mica sheet to facilitate proper placement of the mica sheet within the battery pack.

The bracket 600 can include a plurality of sidewalls 615. For example, a first sidewall 615 can extend from an edge of a first side 620 of the base 605 and a second sidewall 615 can extend from an edge of a second side 620 of the base 605. The first sidewall 615 can be symmetrical (within 10%) with the second sidewall 615. For example, the first sidewall 615 can be rotationally symmetric with the second sidewall 615. The first sidewall 615 can be aligned with the second sidewall 615 or offset from the second sidewall 615. A first tab region 645 extending from the first sidewall 615 can be disposed at a first elevation and a second tab region 645 extending from the second sidewall 615 can be disposed at a second elevation. The first elevation and the second elevation can be the same. The first elevation can be different than the second elevation. When the first elevation is different than the second elevation, a height of a first projection 650 extending from the first tab region 645 can be different than a height of a second projection 650 extending from the second tab region 645. The height of the first projection 650 can be based on the height of the second projection 650 such that a face 655 of the first projection 650 can be coplanar with a face 655 of the second projection 650 (e.g., at the same elevation).

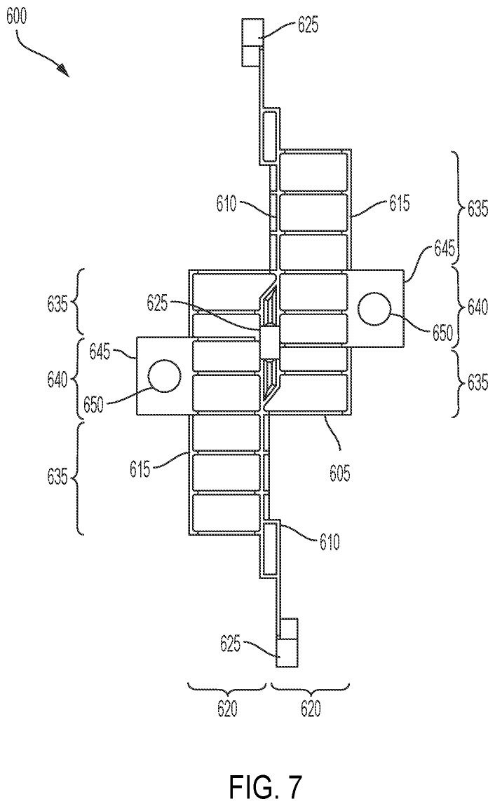

FIG. 7 depicts an example top view of bracket 600. The divider 610 can divide the base 605 into a first side 620 and the second side 620. The divider 610 can be straight or can have any number of offsets. The divider 610 can extend at least as long as the base 605. The divider 610 can extend beyond the ends of the base 605. For example, the length of the divider 610 can be based on a length of the busbars supported by the base 605. The first side 620 of the base 605 can be the same size and shape as the second side 620 of the base 605. The first side 620 of the base 605 can be offset set from the second side 620 of the base 605. The first side 620 and the second side 620 can also be aligned. A first sidewall 615 extending from a first side 620 of the base 605 can be, for example, rotationally symmetrical (plus or minus 10%) with a second sidewall 615 extending from a second side 620 of the base. For example, a length of a first outer portion 635 of the first sidewall 615 can match a length of a first outer portion 635 of the second sidewall 615, a length of a second outer portion 635 of the first sidewall 615 can match a length of a second outer portion 635 of the second sidewall 615, and a length of an inner portion 640 of the first sidewall 615 can match a length of an inner portion 640 of the second sidewall 615. A first tab region 645 extending from the first sidewall 615 can be offset from a second tab region 645 extending from the second sidewall 615. The first tab region 645 can also be aligned with the second tab region 645.

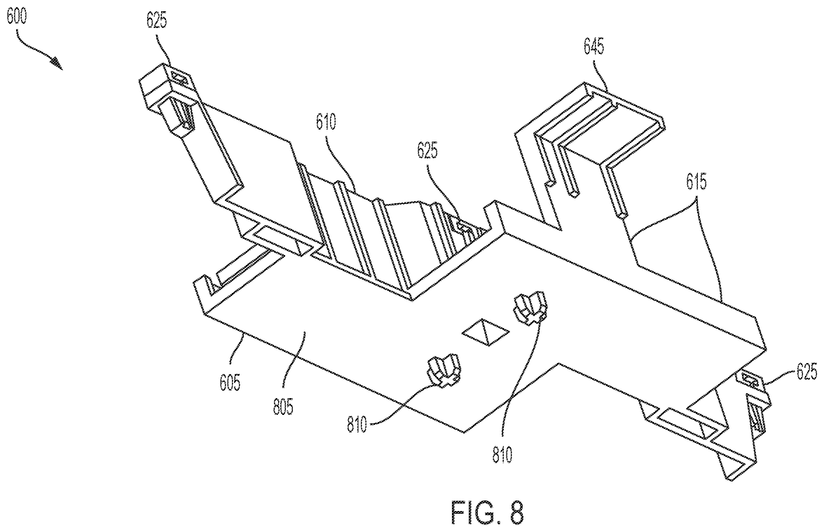

FIG. 8 depicts example bracket 600. Base 605 of bracket 600 can include a bottom surface 805. Bracket 600 can include at least one locating feature 810 extending from the bottom surface 805 of the base 605. The locating feature 810 can facilitate proper alignment of the bracket 600 within a battery pack. For example, the locating feature 810 can align with a cavity of a structural member of the battery pack when the bracket 600 is installed in the battery pack. The bracket 600 can include a plurality of locating features 810. For example, a first locating feature 810 can extend from a bottom surface 805 of a first side 620 of the base 605 and a second locating feature 810 can extend from a bottom surface 805 of a second side 620 of the base 605. The locating feature 810 can comprise any shape in order to coincide with a corresponding locating feature of the battery pack.

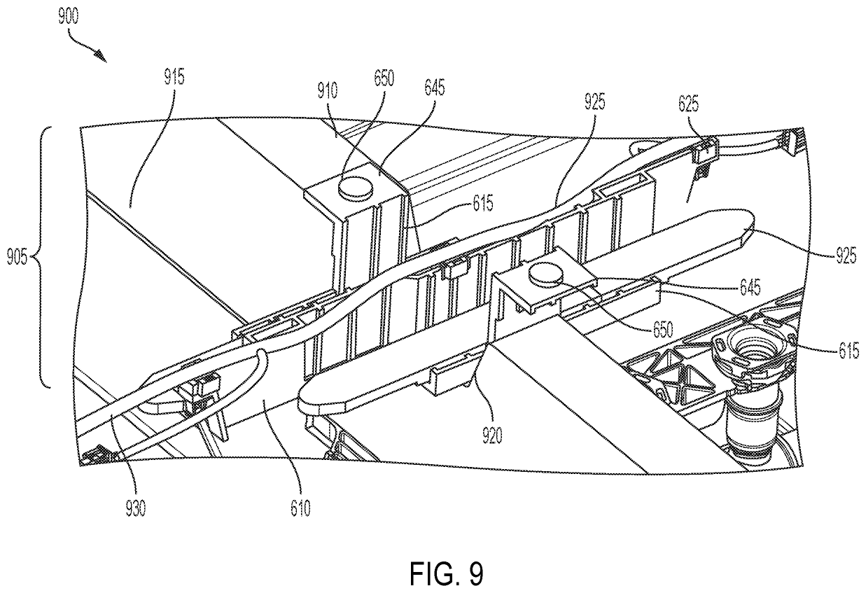

FIG. 9 depicts a battery pack 900. Battery pack 900 can be the same as or different than battery pack 400. Battery pack 900 can be battery pack 110. The battery pack 900 can include at least one structural member 905. The structural member 905 can separate a first battery module of the battery pack 900 from a second battery module of the battery pack 900. Structural member 905 can include an upper member 910 and a lower member 915. Upper member 910 can be coupled with lower member 915. For example, upper member 910 can be bolted together with lower member 915. Upper member 910 can include a cutout 920. Bracket 600 can be configured to be disposed within the cutout 920. For example, the cutout 920 can receive the bracket 600. For example, the bottom surface 805 of the base 605 of the bracket 600 can be configured to interface with an internal surface of the cutout 920. A locating feature 810 of the bracket 600 can align with a cavity of the upper member 910 disposed within the cutout 920. A portion of a sidewall 615 of the bracket 600 can interface with an internal surface of the cutout 920. The sidewall 615 can extend from within the cutout 920 to an elevation above a top surface of the upper member 910. A tab region 645 of the sidewall 615 can be disposed at an elevation above the top surface of the upper member 910.

The battery pack 900 can include at least one busbar 925. The base 605 of the bracket 600 can be configured to support a busbar 925. For example, the busbar 925 can be supported by a first side of the base 605. A bottom surface of the busbar 925 can interface with the base 605. The divider 610 of the bracket 600 can be disposed on a first side of the busbar 925 and a sidewall 615 of the bracket 600 can be disposed on a second side of the busbar 925. The busbar 925 can couple with a battery module disposed within the battery pack 900. The base 604 of the bracket 600 can be clamped between the busbar 925 and the upper member 910 of the structural member 905. For example, when the busbar 925 is coupled with the battery module, the busbar 925 can apply pressure to the base 605 which can be supported by the upper member 910 of the structural member 905 when disposed in the cutout 920.

The battery pack 900 can include at least one harness 930. The harness can connect low voltage features together within the battery pack. A plurality of connectors 625 can be disposed along the divider 610 of the bracket 600 to mechanically retain the harness 930. For example, a first connector 625 can be disposed at a first end of the divider 610, a second connector 625 can be disposed proximate a middle of the divider 610, and a third connector 625 can be disposed at a second end of the divider 610. The first, second, and third connectors 625 can each retain a portion of the harness 930 such that the harness is mechanically retained via the connectors 625 and extends along the length of the divider 610.

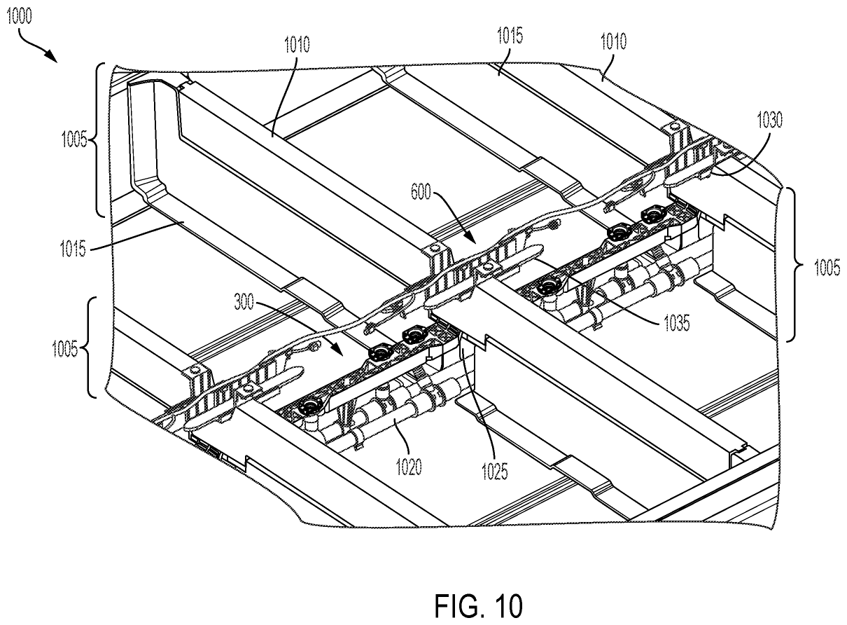

FIG. 10 depicts a battery pack 1000. Battery pack 1000 can be the same as, or different from, battery pack 400 and battery pack 900. Battery pack 1000 can be battery pack 110. Battery pack 1000 can include at least one battery module 115, at least one structural member 1005, at least one bracket 300, and at least one bracket 600. Structural member 1005 can include an upper member 1010 and a lower member 1015. The battery pack 1000 can include a plurality of structural members 1005. For example, battery pack 1000 can include a first structural member 1005 and a second structural member 1005. The battery pack 1000 can include a plurality of battery modules 115. The plurality of structural members 1005 can to separate the plurality of battery modules 115. For example, the plurality of structural members 1005 can define a plurality of pods for the plurality of battery modules 115. Bracket 300 can extend between the first structural member 1005 and the second structural member 1005. A first end portion 310 can be clamped between an upper member 1010 of the first structural member 1005 and a lower member 1015 of the first structural member 1005. A second end portion 310 can be clamped between an upper member 1010 of the second structural member 1005 and a lower member 1015 of the first structural member 1005.

The battery pack 1000 can include at least one cooling line 1020. The cooling line 1020 can couple with a thermal component 215 of the battery pack 1000. The cooling line 1020 can pass through a passage 1025 defined by the lower member 1015 of the structural member 1005. The cooling line 1020 can pass through a plurality of passages 1025 defined by a plurality of lower members 1015. For example, a first lower member 1015 can define a first passage 1025 and a second lower member 1015 can define a second passage 1025. The first and second passages 1025 can be aligned or can be offset. The bracket 300 can include a protrusion 355. The protrusion 355 can to couple with at least one cooling line 1020 of the battery pack 1000. The battery pack 1000 can have a plurality of cooling lines 1020. The protrusion 355 can couple with the plurality of cooling lines 1020. The protrusion 355 can keep the cooling lines 1020 running parallel with the member 305 of the bracket 300.

The cooling lines 1020 can have at least one branch 440. The connection point 320 of the bracket 300 can be configured to facilitate fluid coupling between the cooling lines 1020 and a cooling component by securing a positon of the branch 440. The connection point 320 can laterally align with the branch 440. The connection point 320 can directly couple with the branch 440 or the connection point 320 can couple with a connection device 445 configured to easily couple with the branch 440.

The upper member 1010 of the structural member 1005 can include a cutout 1030. The cutout 1030 can be at least partially aligned with the passage 1025 of the lower member 1015. The cutout 1030 can be configured to receive bracket 600. Bracket 600 can be disposed within cutout 1030. A tab region 645 of the bracket 600 can extend above a top surface of the upper member 1010. The projection 650 of the tab region 645 can be configured to support a sheet-like component of the battery pack 1000. For example, battery pack 1000 can include a mica sheet to lay flat across a top of the battery back 1000. The projection 650 of the tab region 645 can support the mica sheet. The bracket 600 can include a plurality of tab regions 645. Each of the plurality of tab regions 645 can include at least one projection 650. Battery pack 1000 can include a plurality of brackets 600. Each of the plurality of brackets 600 can include a plurality of projections 650 configure to support the mica sheet. The base 605 of the bracket 600 can receive a busbar 1035. The base 605 of the bracket 600 can be clamped between the busbar 1035 and the upper member 1010 when the busbar 1035 is coupled with a battery module of the battery pack 1000.

Battery pack 1000 can include a plurality of brackets 300. For example, a first bracket 300 can extend between a first structural member 1005 and a second structural member 1005 and a second bracket 300 can extend between the second structural member 1005 and a third structural member 1005. Battery pack 1000 can include a plurality of brackets 600. For example, the first structural member 1005 can include a first upper member 1010 with a cutout 1030 to receive a first bracket 600, the second structural member 1005 can include a second upper member 1010 with a cutout 1030 to receive a second bracket 600, and the third structural member 1005 can include a third upper member 1010 with a cutout 1030 to receive a third bracket 600. Each bracket 300, 600 can be configured to be installed within the battery pack 1000 without tools or fasteners. For example, bracket 300 can be installed by the opening 345 of the end portion 310 receiving an alignment pin 510 and the end portion 310 being clamped between an upper member 1010 and a lower member 1015 of a structural member 1005. Bracket 600 can be installed by aligning locating feature 810 with a corresponding cavity disposed within the cutout 1030 of the upper member 1010. A side 620 of the base 605 of the bracket 600 can support a busbar 1035. The base 605 can be clamped between the busbar 1035 and the upper member 1010 when the busbar 1035 is coupled with the battery module. Therefore, when installed, the bracket 600 can interface with the busbar 1035 and the upper member 1010. There can be no fastener directly coupling the bracket 600 with another component. For example, there can be no fastener coupling the bracket 600 with the upper member 1010 and no fastener coupling the bracket 600 with the busbar 1035. Therefore, the bracket 600 can be secured in a position in an absence of a fastener.

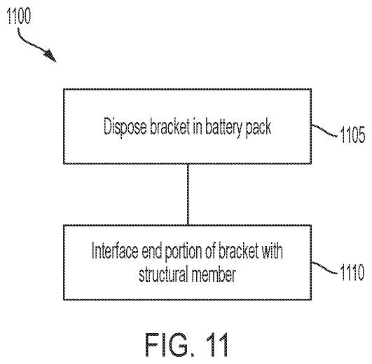

FIG. 11 depicts a flow diagram of an example method 1100. Method 1100 can be a method of installing a bracket. Method 1100 can include disposing a bracket in a battery pack 1105 and interfacing an end portion of the bracket with a structural member (Act 1110). Act 1105 of disposing a bracket in a battery pack can include disposing bracket 300 in battery pack 400. This method can also include disposing bracket 300 into any battery pack (e.g., battery pack 900 and battery pack 1000). Disposing bracket 300 into battery pack 400 can include inserting the bracket 300 into the battery pack 400. Act 1105 can also include aligning an opening 345 of an end portion 310 of the bracket 300 with an alignment pin 510 of at least one structural member 405 of the battery pack 400. For example, battery pack 400 can include a plurality of structural members 405. The plurality of structural members 405 can include a first structural member 405 and a second structural member 405. At least one of the plurality of structural members 405 can include a seat 505. The seat 505 can support an end portion 310 of the bracket 300. For example, the end portion 310 can rest on top of, or interface with, the seat 505. An alignment pin 510 can extend from the seat 505. The opening 345 of the end portion 310 can receive the alignment pin 510. The alignment pin 510 can facilitate proper placement of the bracket 300 and secure the bracket 300 in place (e.g., restrict translational movement). Act 1105 can include aligning a first opening 345 of a first end portion 310 with a first alignment pin 510 disposed on a seat 505 of a first structural member 405 and aligning a second opening 345 of a second end portion 310 with a second alignment pin 510 disposed on a seat 505 of a second structural member 405.

Act 1105 can also include fluidly coupling a cooling line 430 of the battery pack 400 with a cooling component via at least one connection point 320 of the bracket 300. For example, act 1105 can include laterally aligning a connection point 320 with a branch 440 of the cooling line 430. The branch 440 can be coupled with the bracket 300 via the connection point 320. The branch 440 can be either directly coupled with the connection point 320 or via a connection device 445 (e.g., quick connect device). When secured by the connection point 320, the branch 440 is positioned such that fluid can transfer from the cooling line 430 to the cooling component via the branch 440. Act 1105 can include laterally aligning plurality of connection points 320 with a plurality of branches 440.

Act 1110 of interfacing an end portion of a bracket with a structural member can include interfacing end portion 310 of bracket 300 with structural member 405. Structural member 405 can include an upper member 415 and a lower member 420. Lower member 420 can include a seat 505 configured to interface with the end portion 310 of the bracket 300. For example, a bottom surface of the end portion 310 can interface with the seat 505 of the lower member 420. Act 1110 can include interfacing a first end portion 310 of the bracket 300 with a first structural member 405 and interfacing a second end portion 310 of the bracket 300 with a second structural member 405.

Act 1110 can also include clamping the end portion 310 of the bracket 300 between the upper member 415 of the structural member 405 and the lower member 420 of the structural member 405. For example, when the end portion 310 is interfacing with the seat 505 of the lower member 420, the upper member 415 can be disposed above the lower member 420 such that a portion of the upper member 415 interfaces with a stop surface of the end portion 310. The end portion 310 of the bracket 300 can be disposed between the seat 505 of the lower member 420 and a bottom surface of the upper member 415. The upper member 415 can be coupled with the lower member 420. Coupling the upper member 415 with the lower member 420 causes a force to be exerted on the end portion 310, securing the bracket 300 in place.

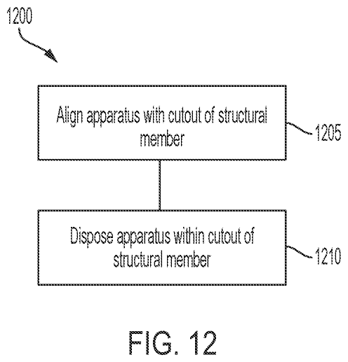

FIG. 12 depicts a flow diagram of an example method 1200. Method 1200 can be a method of installing a bracket. Method 1200 can include aligning a bracket with a cutout of a structural member 1205 and disposing the bracket within the cutout 1210. Act 1205 of aligning a bracket with a cutout of a structural member can include aligning bracket 600 with cutout 920 of structural member 905 of battery pack 900. This method can also include aligning a bracket with a cutout of a structural member of any battery pack (e.g., battery pack 400 and battery pack 1000). Aligning the bracket 600 can include aligning a locating feature 810 of the bracket 600 with a corresponding cavity of the structural member 905. For example, bracket 600 can include at least one locating feature 810. The locating feature 810 can extend from a bottom surface 805 of the bracket 600. Structural member 905 can include at least one cavity that corresponds with the at least one locating feature 810. The cavity can be disposed in the cutout 920 of the structural member 905. The structural member 905 can have an upper member 910 and a lower member 915. The cutout 920 can be disposed in the upper member 910.

Act 1210 of disposing a bracket within a cutout of a structural member can include disposing bracket 600 within cutout 920 of structural member 905. Act 1210 can include positioning the bracket 600 such that the bottom surface 805 of the bracket 600 interfaces with a surface of the structural member 905. Act 1210 can also include securing the bracket 600. Securing the bracket 600 can include clamping the base 605 of the bracket between a busbar 925 and the structural member 905. Securing the bracket 600 can include disposing a busbar 925 on a first side 620 of a base 605 of the bracket 600. The busbar 925 can couple with a first battery module 115 and a second battery module 115. Securing the bracket 600 can include coupling the busbar 925 with the first and second battery modules 115. As the busbar 925 is coupled with the battery modules 115, the busbar 925 applies pressure to the first side 620 of the base 605 of the bracket 600 and clamps the base 605 between the busbar 925 and the structural member 905. Securing the bracket 600 can include disposing a first busbar 925 on the first side 620 of the base 605 and disposing a second busbar 925 on a second side of the base 605. The divider 610 can separate the first busbar 925 from the second busbar 925.

Act 1210 can also include positioning a harness 930. For example, battery pack 900 can include a harness 930. The harness 930 can be a low-voltage harness configured to carry current between low-voltage components of the battery pack 900. Bracket 600 can include at least one connector 625 to mechanically retain the harness 930. The connector 625 can be disposed on top of the divider 610. For example, the harness 930 can snap into the connector 625. Bracket 600 can include a plurality of connectors 625. For example, a first connector 625 can be disposed at a first end of the divider 610, a second connector 625 can be disposed proximate a center of the divider 610, and a third connector 625 can be disposed at a second end of the divider 610. A first portion of the harness 930 can snap into the first connector 625, a second portion of the harness 930 can snap into the second connector 625, and a third portion of the harness 930 can snap into the third connector 625.

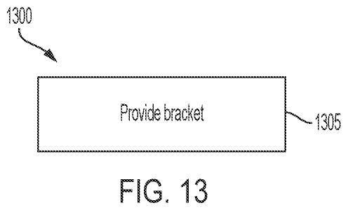

FIG. 13 depicts a flow diagram of an example method 1300. Method 1300 can be a method of providing a bracket. Method 1300 can include providing a bracket 1305. Act 1305 can include providing a bracket 300. The bracket 300 can include a member, shown as member 305, to extend between a first structural member 405 and a second structural member 405. The bracket 300 can include at least one connection point 320. The connection point 320 can be integrated with the bracket 300. The connection point 320 can be configured to facilitate a fluid coupling between a cooling line

Act 1305 can include providing a bracket 600. Bracket 600 can include a base 605. Bracket 600 can also include a divider 610. The divider 610 can extend vertically from the base 605. The divider 610 can separate a first side 620 of the base 605 from a second side 620 of the base 605. Bracket 600 can include at least one sidewall 615 disposed on a side 620 of the base 605. The at least one sidewall 615 can include a tab region 645. Bracket 600 can include a plurality of sidewalls 615. For example, bracket 600 can include a first sidewall 615 disposed on a first side 620 of the base 605 and a second sidewall 615 disposed on a second side 620 of the base 605. Act 1305 can also include providing both bracket 300 and bracket 600.

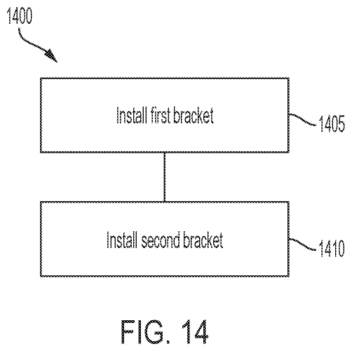

FIG. 14 depicts a flow diagram of an example method 1400. Method 1400 can be a method of installing a plurality of brackets in a battery pack. Method 1400 can include installing a first bracket 1405 and installing a second bracket 1410. Act 1405 can include installing at least one first bracket in the battery pack 1000. The first bracket can be bracket 300. Act 1405 can include aligning a first opening 345 of a first end portion 310 of the bracket 300 with a first alignment pin 510 of a first lower member 1015 and aligning a second opening 345 of a second end portion 310 of the bracket 300 with a second alignment pin 510 of a second lower member 1015. Act 1405 can include interfacing a bottom surface of the first end portion 310 with a seat of the first lower member 1015 and interfacing a bottom surface of the second end portion 310 with a seat 505 of the second lower member 1015. Act 1405 can include coupling at least one cooling line 1020 with bracket 300. Coupling the cooling line 1020 can include coupling a branch 440 of the cooling line 1020 with the bracket 300 via a connection point 320. Act 1405 can include coupling a plurality of branches 440 with the bracket 300 via a plurality of connection points 320. Act 1405 can include stabilizing the cooling line 1020 by coupling the cooling line 1020 with a protrusion 355 of the bracket 300. The protrusion 355 can stabilize a plurality of cooling lines 1020. Act 1405 clamping the first end portion 310 between a first upper member 1010 and the first lower member 1015 and clamping the second end portion 310 between a second upper member 1010 and the second lower member 1015. Act 1405 can include coupling a first upper member 1010 with the first lower member 1015 and coupling a second upper member 1010 with the second lower member 1015.

Act 1410 can include installing at least one second bracket in the battery pack 1000. The second bracket can be bracket 600. Act 1410 can include aligning bracket 600 with a cutout 920 of the first upper member 1010. Aligning the bracket 600 with the cutout 920 can include aligning at least one locating feature 810 of the bracket 600 with a corresponding cavity disposed in the cutout 920 of the first upper member 1010. Act 1410 can include interfacing a bottom surface 805 of the bracket 600 with a surface of the first upper member 1010. The surface can be disposed in the cutout 920. Act 1410 can include disposing at least one busbar 1035 on a first side 620 of the bracket 600. Act 1410 can include clamping the first side 620 of the bracket 600 between the busbar 1035 and the first upper member 1010. Act 1410 can include coupling the busbar 1035 with a first battery module 115 and a second battery module 115. Installation of the first bracket and the second bracket can be performed with access to only one side of the battery pack 1000.)

Some of the description herein emphasizes the structural independence of the aspects of the system components or groupings of operations and responsibilities of these system components. Other groupings that execute similar overall operations are within the scope of the present application. The systems described above can provide multiple ones of any or each of those components and these components can be provided on either a standalone system or on multiple instantiation in a distributed system.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a member to extend between a first structural member and a second structural member;
at least one connection point integrated with the member, the at least one connection point configured to facilitate a fluid coupling between a cooling line and a cooling component; and
at least one end portion of the member, the at least one end portion configured to interface with a seat of at least one of the first structural member and the second structural member.

2. The apparatus of claim 1, comprising:
the member being an elongated portion;
the at least one end portion comprising an opening configured to receive an alignment pin of the at least one of the first structural member and the second structural member; and
the seat of the at least one of the first structural member and the second structural member configured to support the apparatus.

3. The apparatus of claim 1, wherein the at least one end portion is configured to be clamped between an upper member of the first structural member and a lower member of the first structural member.

4. The apparatus of claim 1, comprising:
the at least one end portion comprising a locating feature, wherein the locating feature is configured to receive a battery pack component.

5. The apparatus of claim 1, comprising:
the at least one connection point configured to secure a connection device to couple the cooling line with the apparatus.

6. The apparatus of claim 1, wherein the at least one connection point is disposed at a location along the member to longitudinally align with a branch point of the cooling line when the apparatus is installed in a battery pack.

7. The apparatus of claim 1, comprising:
a protrusion extending from the member of the apparatus, the protrusion configured to support the cooling line.

8. The apparatus of claim 1, comprising a protrusion extending from a bottom surface of the member, the protrusion configured to keep the cooling line substantially parallel with the member of the apparatus.

9. The apparatus of claim 1, wherein the apparatus can be installed in a battery pack without fasteners.

10. An apparatus, comprising:
a base;
a divider extending vertically from the base, the divider configured to separate a first side of the base from a second side of the base; and
at least one sidewall disposed on at least one of the first side and the second side of the base, the at least one sidewall comprising a tab region.

11. The apparatus of claim 10, wherein the first side of the base is configured to support a first busbar and the second side of the base is configured to support a second busbar, the divider configured to separate the first busbar from the second busbar.

12. The apparatus of claim 10, wherein the base is configured to be clamped between a busbar and a structural member of a battery pack.

13. The apparatus of claim 10, comprising:
a locating feature extending from a bottom surface of the base, the locating feature configured to align with a cavity of a structural member of a battery pack when the apparatus is installed in the battery pack.

14. The apparatus of claim 10, comprising:
a connector on the divider, the connector configured to mechanically retain a low-voltage harness.

15. The apparatus of claim 10, comprising:
a projection disposed on the tab region, the projection configured to support a sheet-like component of a battery pack.

16. The apparatus of claim 10, wherein the apparatus can be installed in a battery pack without fasteners.

17. A method, comprising:
disposing a bracket within a battery pack, the bracket comprising:
a member to extend between a first structural member and a second structural member of the battery pack;
at least one connection point integrated with the member, the at least one connection point configured to facilitate a fluid coupling between a cooling line and a cooling component within the battery pack; and
at least one end portion of the member; and
interfacing the at least one end portion of the bracket with a seat of at least one of the first structural member and the second structural member.

18. The method of claim 17, comprising:
aligning an opening of the at least one end portion with an alignment pin of the at least one of the first structural member and the second structural member, the alignment pin disposed on the seat.

19. The method of claim 17, comprising:
fluidly coupling the cooling line with the cooling component via the at least one connection point of the bracket.

20. The method of claim 17, comprising:
clamping the at least one end portion of the bracket between an upper member of the first structural member and a lower member of the first structural member.
